(19) United States
(12) Patent Application Publication
(10) Pub. No.: US 2012/0075110 A1
(43) Pub. Date: Mar. 29, 2012

(54) SUBJECT DETECTION

(75) Inventors: Sabri Boughorbel, Eindhoven (NL); Alphons Antonius Maria Lambertus Bruekers, Nederweert (NL); Koen Theo Johan De Grcot, Eindhoven (NL); Dirk Jeroen Breebaart, Eindhoven (NL)

(73) Assignee: KONINKLIJKE PHILIPS ELECTRONICS N.V., EINDHOVEN (NL)

(21) Appl. No.: 13/322,680

(22) PCT Filed: Jun. 8, 2010
(86) PCT No.: PCT/IB10/52541

§ 371 Date: Nov. 28, 2011

(30) Foreign Application Priority Data
Jun. 11, 2009 (EP) 09162469

(51) Int. Cl. G08B 21/00

(52) U.S. Cl. 340/686.6

(57) ABSTRACT

The application describes a child monitoring system and method for detecting and discriminating between children and adults passing under a sensor that is independent of the position of the sensor in relation to the subject. The system determines a distance to a surface on which a person can stand, and calculates a reference distance from this distance and a desired threshold. When a person enters the sensor range, the distance to the top of the person's head is compared with the reference distance to determine whether the person is an adult or a child. An alert can be provided when a child is detected as opposed to an adult, and alerts can be suppressed if an adult is in the vicinity.

### FIELD OF THE INVENTION

This invention relates generally to a method and system for detecting a subject, in particular a person. More particularly, but not exclusively, it relates to a child monitoring system for discriminating between children and adults entering areas that may pose dangers to children.

### BACKGROUND OF THE INVENTION

Parents are caught in a dilemma between protecting and caring for their children versus providing them with the freedom and opportunities that will aid in their personal development. It is known that many accidents and unintentional injuries happen to children as a result of them wandering into potentially risky areas at home in the absence of a supervising adult.

Barriers are therefore commonly installed by parents seeking to prevent the occurrence of such child accidents. In many situations however, it is sufficient to merely alert parents that their children are entering a potentially dangerous area rather than erecting barriers to prevent entry, as the barriers might cause inconvenience to other family members.

US2005/0122224 discloses an electronic fence system in which a perimeter is set up with sensors and the child wears an electronic transmitter that interacts with the sensors. Such a system relies on the child or other individual being monitored always wearing or carrying the transmitter.

### SUMMARY OF THE INVENTION

According to a first aspect of the present invention, there is provided a method of detecting a subject using a sensor mounted above a surface, the method comprising determining a first distance from the sensor to the surface, determining a second distance from the sensor to a subject and determining whether to provide an alert in dependence on the first and second distances.

The method may further comprise determining a reference distance based on the first distance and a height threshold, comparing the second distance to the reference distance, and determining whether to provide the alert in dependence on the result of the comparison.

By determining a reference distance based on the first distance and a height threshold, the sensor can operate independently of its mounting position, so that there is no need to adjust the height of the sensor itself relative to the desired height threshold. This makes for simple installation.

Determining the reference distance may comprise subtracting the height threshold from the first distance.

The method may comprise providing an alert if the second distance exceeds the reference distance. This reflects the case where an individual, typically a child smaller than the selected height threshold, is detected.

The method may further comprise subtracting the second distance from the first distance to determine a height of the subject, and comparing the height of the subject to a height threshold to determine whether to provide the alert.

Alternatively, the method may comprising measuring the second distance based on a known angle of the sensor with respect to the subject; and calculating the height of the subject based on the measured second distance, the first distance and the angle.

The sensor may therefore be mounted at an angle to a door frame and other support structure, and still be able to calculate the height of an approaching subject.

The method may comprise providing an alert by using a result of the comparison in combination with one or more rules governing the provision of alerts to a user. Any number of rules can be specified depending on the circumstances. For example, in a simple case, an alert may be provided when a child passes under the sensor, but not when an adult passes under the sensor. As another example, an alert raised as a result of a child passing under the sensor may be suppressed when an adult passes through the sensor within a predetermined time frame. Alternatively, an alert may be suppressed when an adult is already in an area that is entered by a child.

Providing the alert may comprise at least one of operating an audio or visual warning device and sending an electronic message. Alternatively, the alert may comprise haptic feedback using a vibrating device.

The determining of the first distance may be performed during a calibration phase or may be performed during operation of the device, for example at predetermined intervals when the device is otherwise idle.

The method may further comprise recording the detection of the subject as an event entry on a processor-based system coupled to the sensor. This enables functionality such as determining that an adult is already present in an area subsequently entered by a child.

According to a second aspect of the invention, there is provided a system for detecting a subject positioned on a surface, the system comprising a sensor mountable to a support for detecting the subject, means for determining a first distance from the sensor to the surface under the sensor, means for determining a second distance from the sensor to a subject and means for determining whether to provide an alert in dependence on the first and second distances.

The claimed means may all be implemented within a single processor that receives signals from the sensor.

The sensor may be mountable at an angle with respect to the support, which allows flexibility in mounting that depends on the desired area to be monitored.

The system may comprise first and second sensors, wherein the first sensor is arranged with a narrow beam to detect a child under the sensor, and the second sensor is arranged with a wider beam to detect an adult further away from the sensor. As a result, alerts that might otherwise result can be suppressed. The two sensors can be used to determine whether the child or adult has entered or left the potentially dangerous area.

These and other aspects of the invention will be apparent from and elucidated with reference to the embodiments described hereinafter.

### BRIEF DESCRIPTION OF THE DRAWINGS

Embodiments of the invention will now be described with reference to the accompanying drawings, in which:

FIG. 1 illustrates a schematic block diagram of a child monitoring system in accordance with an embodiment of the invention;

FIG. 2 is an exemplary scenario in which the child monitoring system of FIG. 1 is used;

FIG. 3 illustrates a first embodiment of the operating phases of the child monitoring system of FIG. 1;

FIG. 4 illustrates a second embodiment of the operating phases of the child monitoring system of FIG. 1;

FIG. 5 illustrates a mounting arrangement of a sensor of the child monitoring system of FIG. 1 to a support;

FIG. 6 illustrates a third embodiment of an operating phase of the child monitoring system of FIG. 1 when the sensor is configured according to FIG. 5;

FIG. 7 illustrates a graph of the measured heights of subjects detected by the child monitoring system of FIG. 1 as a function of time;

FIG. 8 is a flow diagram illustrating a first scheme under which the child monitoring system of FIG. 1 is operated to in accordance with the embodiment of FIG. 3;

FIG. 9 is a flow diagram illustrating a second scheme under which the child monitoring system of FIG. 1 is operated to in accordance with the embodiment of FIG. 4;

FIG. 10 is a flow diagram illustrating a third scheme under which the child monitoring system of FIG. 1 is operated to in accordance with the embodiment of FIG. 6; and

FIG. 11 illustrates a schematic block diagram in which multiple child monitoring systems are communicatively linked to and controlled via a master control unit for supporting usage of advanced applications.

### DETAILED DESCRIPTION OF THE EMBODIMENTS

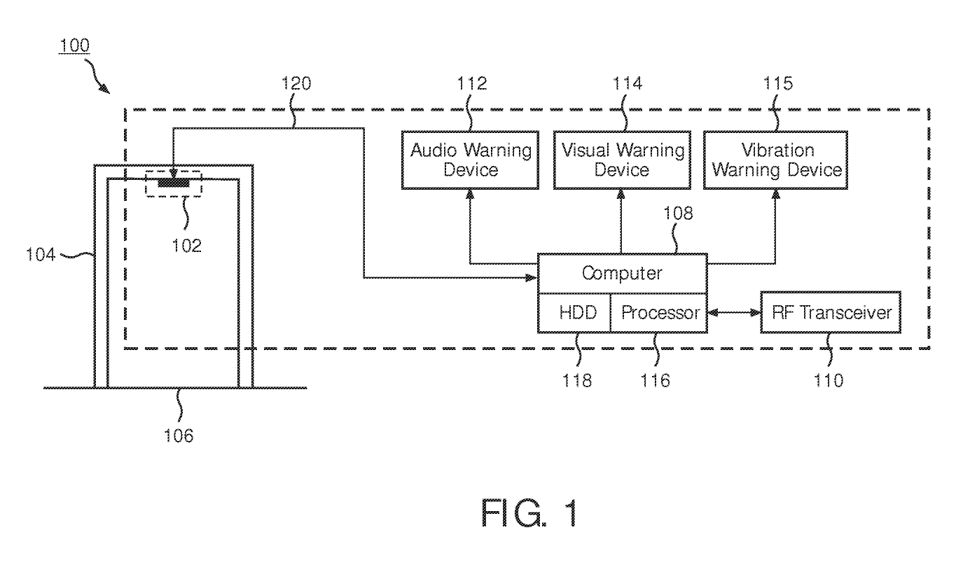

FIG. 1 illustrates a schematic block diagram of a child monitoring system 100 in accordance with an embodiment of the invention. The system 100 comprises a sensor 102 mounted onto a support 104, such as a door frame. The support 104 is secured to a base 106, also referred to as a surface 106, such as a floor. The sensor 102 is, for example, an ultrasonic transducer that emits sound waves in pulses for enabling the timing of the echoes from the pulses to determine the distance from the sensor 102 to a target. Alternatively, a photoelectric sensor, laser sensor or an infrared sensor or other types of sensors having equivalent functionality may also be employed for use as the sensor 102.

The use of an ultrasonic transducer as the sensor 102 may substantially reduce the frequency of false alarms since ultrasonic signals are incapable of penetrating walls or other similar structures. The use of ultrasonic signals instead of radio frequency (RF) signals, such as used in RFID systems, may also be perceived by parents as safer. In addition, the subjects are not required to carry or wear RF identification tags. As an example, the ultrasonic transducer has a specification comprising a transmitting frequency of between 21-170 kHz with a beam angle of less than 21°. Different beam angles and beam shapes permit use in different situations. For example, a wider beam allows the system 100 to be deployed at a door passage while a cone shaped beam may be suitable for deploying the system 100 to guard a hot stove in the kitchen.

The system 100 also comprises a processor-based system 108 that is coupled to the sensor 102. The processor-based system 108 is in turn coupled to an RF transceiver 110, an audio warning device 112, a visual warning device 114 and a vibrating warning device 115. The RF transceiver 110 may be equipped for transmitting emails, short-message-service (SMS) messages or voicemail messages. In one embodiment, the processor-based system 108 is an embedded computer equipped with a microprocessor 116 and a storage device 118. The storage device 118 may be a solid-state drive (SSD) which may use either static-RAM (SRAM) or dynamic-RAM (DRAM) as storage memory modules. Optionally, the storage device 118 may also be a regular hard-drive, a magnetic tape storage device or the like. In addition, the processor-based system 108 is preferably installed with an embedded real-time operating system (e.g. RT-LINUX, MicroC/OS-II, QNX or VxWorks) which includes various software components and/or drivers for controlling and managing real-time system tasks (e.g. memory management, storage device control, power management and the like) and facilitating intercommunications between various hardware and software components of the processor-based system 108. In one embodiment, the system 100 is realized and implemented as an independent standalone device, with a small form factor, that can easily and conveniently be deployed anywhere.

The audio warning device 112 may enable a plurality of pre-programmed audio warning messages to be stored and also allows the volume level when broadcasting the warning messages to be adjusted. On the other hand, the visual warning device 114 may include flashing lights or other similar mechanisms to capture the attention of adults by providing alerts when activated. The processor-based system 108 is further coupled to the sensor 102 via a communication link 120 which is preferably established wirelessly, using a communication protocol such as Bluetooth, wireless universal-serial-bus (WUSB), Wireless Fidelity (Wi-Fi) or any equivalents known to persons skilled in the art. Alternatively, the communication link 120 may also be established via conventional wired means.

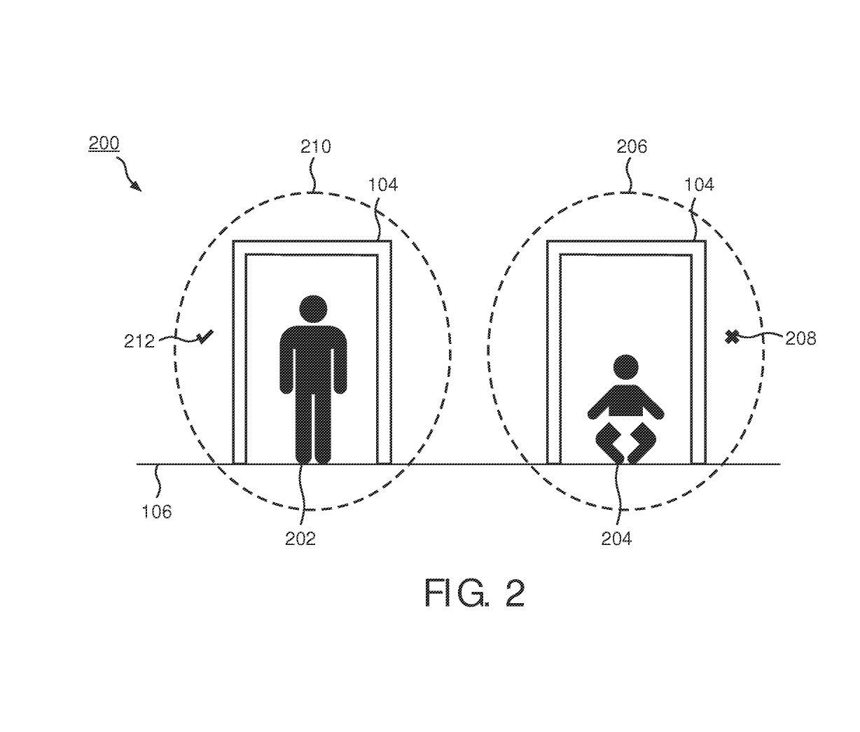

FIG. 2 shows an exemplary scenario in which the system 100 is deployed for detecting and differentiating between an adult 202 and a child 204 passing through the support 104 at different times. As illustrated, the system 100 alerts supervising adults nearby when a child 204 passes through the support 104 into an area being monitored in accordance with a first detection condition 206. The occurrence of the first detection condition 206 raises an exception to the system 100 as an event that is not permitted, as indicated by the cross 208. However, the system 100 is silent and does not provide any alerts when the detection of adults entering the same area in accordance with a second detection condition 208. This is classified by the system 100 as a permitted event, indicated by a tick 212.

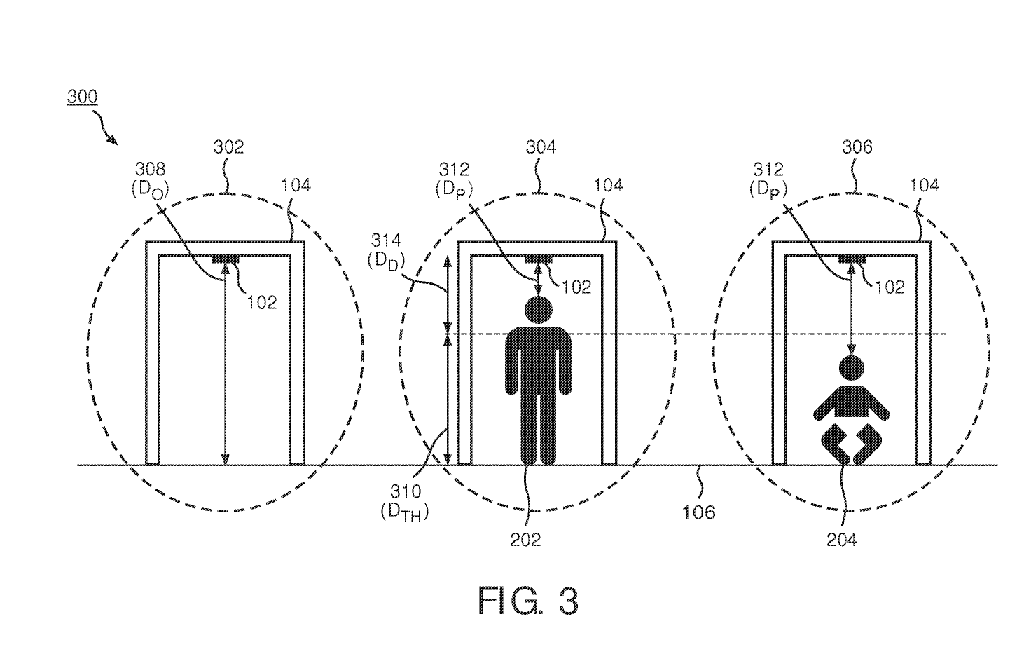

FIG. 3 illustrates the operating phases of the system 100 in which they can accordingly be classified as: a calibration phase 302, an adult detection phase 304 and a child detection phase 306 respectively. The adult and child detection phases 304, 306 are also collectively known as a subject detection phase. In the calibration phase 302, the system 100 measures a first distance 308, defined to be the distance between the sensor 102 and the base 106. The first distance 308 may be termed D_{O}. Specifically, the first distance 308 may vary depending on where the sensor 102 is mounted. Hence, a recalibration is required whenever the system 100 is deployed in a new location or shifted to a new position. The calibration phase 302 may be initiated through a variety of means, including pressing an associated button provided by the system 100, recalibrating after replacing the batteries for powering the sensor 102, performing analysis of the first distance 308 when no subject is detected for a period of time or the like. Optionally, the system 100 may be configured to perform the calibration phase 302 automatically at predetermined intervals to ensure that accuracy of subject detection is maintained.

Next, depending on the discrimination in height a supervising adult (not shown) operating the system 100 wishes to make against a subject passing through the support 104, a threshold distance 310 is then defined, which is also referred to herein as a height threshold. This will, for example, be above the maximum height of a child that the supervising adult wishes to prevent passing through, but below the height of other children or adults that should be allowed to pass through without raising an alarm. The threshold distance 310 may be termed D_{TH}.

When the height of a subject detected by the system 100 is below the threshold distance 310, an alert is raised, whereas if the subject is taller than the threshold distance 310, no alert is required. Consequently, it is to be appreciated that the threshold distance 310 defines the sensitivity of the system 100 and also the frequency of false alarms. For ease and convenience, the system 100 may optionally include predefined “threshold profiles” to enable the supervising adult operating the system 100 to select an appropriate threshold distance 310 for an environment the system 100 is deployed in. Conversely, the system 100 may also allow the supervising adult to manually enter a suitable threshold distance 310 instead.

During the subject detection phase 304, 306, the system 100 measures a second distance 312, defined as the distance between the sensor 102 and a top portion of the subject (for example, the head of the adult 202 or child 204). The subject is preferably momentarily positioned vertically underneath the sensor 102 at the moment of detection. The second distance 312 may be termed D. The system then calculates a third distance 314, referred to herein as a reference distance, that is determined by subtracting the threshold distance 310 from the first distance 308. The reference distance 314 may be termed D_{D} and is expressed as:

D_{D}=D_{O}−D_{TH} (a)

Subsequently, the reference distance 314 is then compared with the second distance 312 to obtain a decision value. In one embodiment, alerts are provided by the system 100 on the basis of the decision value, taken together with the rules below:

### IF D_{P} IS LESS THAN D_{D},

### NO ALERT REQUIRED;

### IF D_{P} IS GREATER THAN OR EQUAL TO D_{D},

### RAISE ALERT;

Specifically, rule (A2) relates to detection of the child 204 and is classified under the child detection phase 306. Rule (A1) relates to detection of the adult 202 and is classified under the adult detection phase 304. This set of rules could be extended with a rule that states no alert is required if D_{P} is sufficiently close but not equal to D₀, since this may indicate that (1) something else rather than a child is detected (e.g. a pet or a toy) or (2) to ensure some robustness against potential measurement noise.

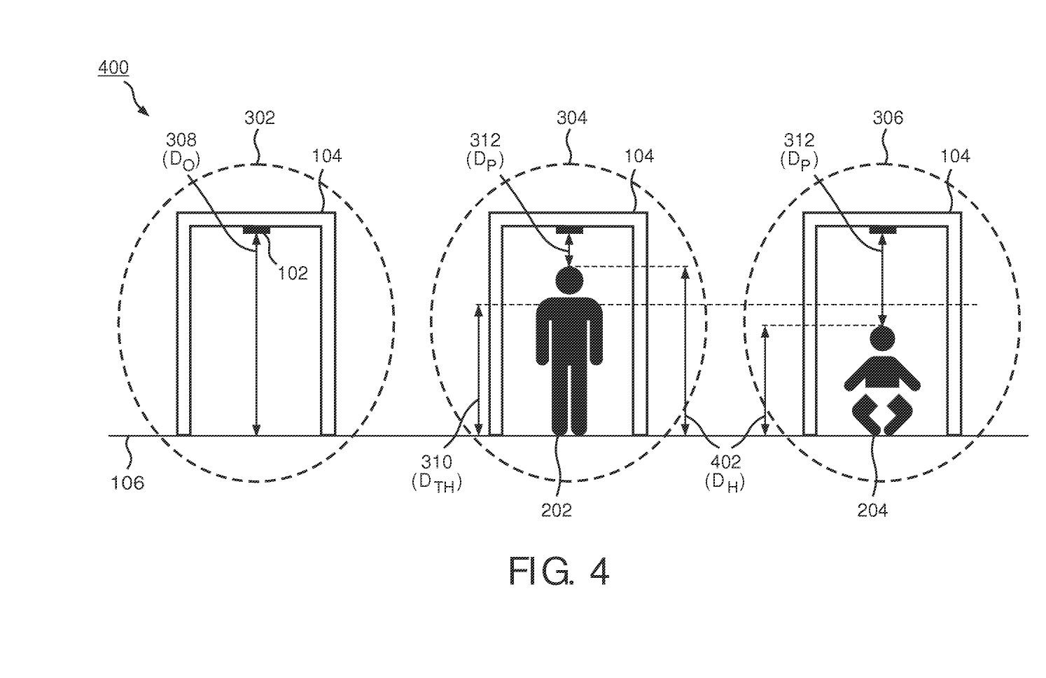

In an alternative embodiment as shown in FIG. 4, in place of the reference distance 314, the height of the subject (referred to as subject height) 402 is instead used for detecting whether an adult 202 or a child 204 has passed through the support 104. The subject height 402 may be termed D_{H} and is calculated by subtracting the second distance 312 from the first distance 308. It is expressed as:

D_{H}=D_{O}−D_{P} (b)

Thereafter, the subject height 402 is then compared with the threshold distance 310 (D_{TH}) to obtain a decision value. In one embodiment, on the basis of the decision value, determination of provision of alerts by the system 100 is made according to the rules below:

### IF D_{H} IS GREATER THAN D_{TH},

### NO ALERT REQUIRED;

### IF D_{H} IS LESSER THAN OR EQUAL TO D_{TH},

### RAISE ALERT;

Similar to the embodiment of FIG. 3, rule (B2) relates to detection of the child 204 and is classified under the child detection phase 306. Rule (B1) hence relates to detection of the adult 202 and is classified under the adult detection phase 304. Likewise, this set of rules could also include the rule which states that no alert is required if D_{P} is sufficiently close but not equal to D_{O}, since this may indicate that (1) something else rather than a child is detected (e.g. a pet or a toy) or (2) to ensure some robustness against potential measurement noise.

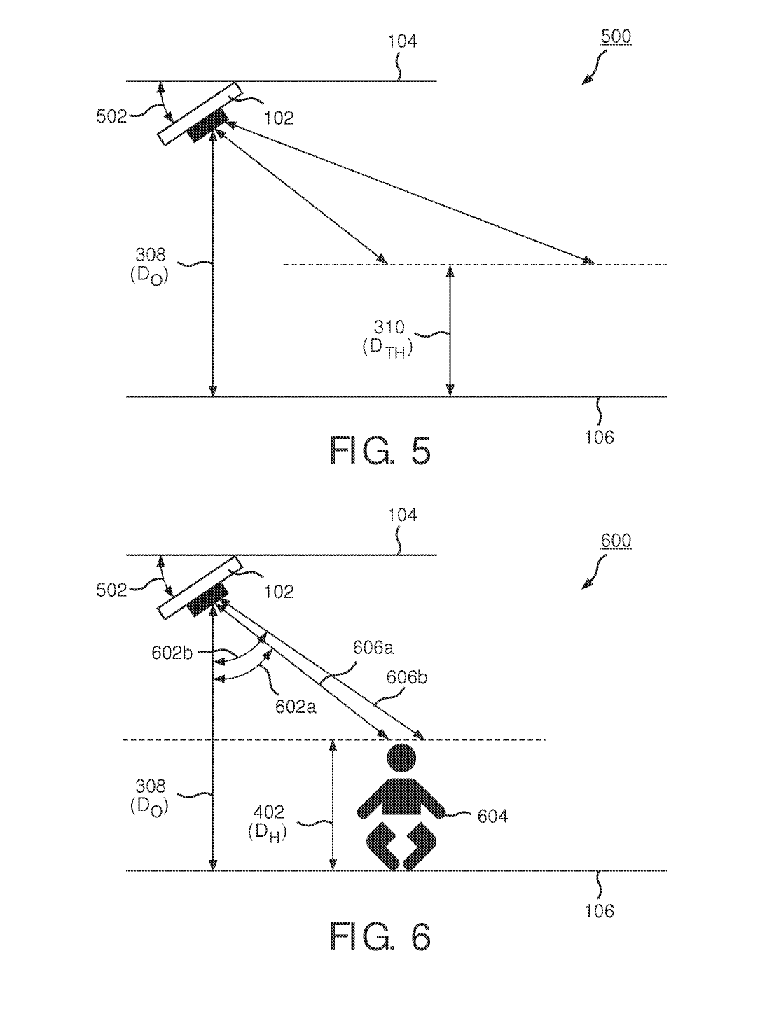

FIG. 5 illustrates a mounting arrangement of the sensor 102 of the system 100 to the support 104. In addition to mounting the sensor 102 directly onto the top portion of the support 104 such as the horizontal frame of a door, the sensor 102 may alternatively be secured at a mounting angle 502 with respect to the horizontal or vertical axes of the support 104 as shown in FIG. 5 in another embodiment. In particular, under such an arrangement, the calibration phase 302 involves the determination of the first distance 308 as well as the mounting angle 502. Yet further, the sensor 102 may also be pivotably mounted to the support 104 such that the mounting angle 502 is flexibly adjustable for enabling subject detection under various different situations. One advantage of this mounting arrangement is that the data received by the sensor may depend on the direction that a person is moving. Specifically, when a subject is moving away from the sensor, the frequency of the signals received by the sensor will decrease due to Doppler shifts, and will increase if the subject is moving towards the sensor. Such frequency shifts can additionally be used to detect the direction of movement.

According to the arrangement shown in FIG. 5, there is yet another embodiment shown in FIG. 6 which enables the subject height 402 to be computed for use during the subject detection phase 304, 306. In this embodiment, it is presumed that the sensor 102 is already mounted onto the support 104 at the desired mounting angle 502 and at a known first distance 308 with respect to the base 106. Further, the sensor 102 is also preconfigured to perform measurements in multiple directions (i.e. for a range of beam angles 602a, 602b) to a subject 604 positioned under the support 104. The beam angles 602a, 602b are defined with respect to an axis perpendicular to the base 106 and may be represented using α. Corresponding to the beam angles 602a, 602b, a resulting range of diagonal distances 606a, 606b is then measurable by the sensor 102. The diagonal distance is defined to be the length being spatially measured from the sensor 102 to the head of the subject 604 and it may be termed D_{DIA}. Subsequently, for a specific data-tuple comprising the first distance 308, the measured diagonal distance 606a, and a beam angle 602a (i.e. [D_{O}, D_{DIA}, α]), the subject height 402 can then be easily calculated using the trigonometry cosine function. The subject height 402 is expressed as:

D_{H}=D_{O}−D_{DIA} Cos(α) (c)

Accordingly from the above, a range of values of the subject height 402 is consequently obtained, from which they are then statistically averaged to arrive at an approximated height profile (D_{H}′) of the subject 604. Thereafter, the height profile is compared with the threshold distance 310 (D_{TH}) to obtain a decision value. In one embodiment, the system 100 assesses whether to provide alerts depending on the decision value and in conjunction with the rules below:

### IF D_{H}′ IS GREATER THAN D_{TH},

### NO ALERT REQUIRED;

### IF D_{H}′ IS LESSER THAN OR EQUAL TO D_{TH},

### RAISE ALERT;

Rule (C2) relates to detection of the child 204 and is classified under the child detection phase 306. Rule (C1) relates to detection of the adult 202 and is classified under the adult detection phase 304. Likewise, this set of rules could also include the rule which states that no alert is required if the height profile (D_{H}′) is sufficiently close but not equal to zero, since this may indicate that (1) something else rather than a child is detected (e.g. a pet or a toy) or (2) to ensure some robustness against potential measurement noise. It is also to be further appreciated that under the special situation where cc is equal to zero (i.e. Cos(α) therefore carries a value of one), equation (c) can be simplified to the following form:

D_{H}=D_{O}−D_{DIA} (d)

Additionally, according to another embodiment, a set of rule extensions may also be predefined in the system 100 to complement the afore-described sets of basic rules listed for the embodiments shown in FIGS. 3 to 6. The set of rule extensions provides contextual child detection under different scenarios and may include the following:

(D1) If a child is detected and an adult is detected within a specified time before or after, no alert is required. Multiple sensors may alternatively be used in this scenario—one to detect the child and another with a wider detection angle to detect the presence of an adult.
(D2) If a child is detected, the direction of movement is also detected. An alarm may be raised in one direction but not in the other. For example, an alarm may be raised on an external door when the child is moving from inside to outside, but not when the child is moving from outside to inside. This can be done by using two sensors, one on each side of the door and determining the order in which the sensors are activated.
(D3) No alarm is raised when the door is closed.
(D4) No alarm is raised when a child passes and an adult has already been logged as already present in the room or area being monitored.
(D5) The alarm may depend on the time of day or on light conditions, for example the alarm may only work at night or when a particular area being monitored is dark.
(D6) No alarm is raised if the child enters a potential dangerous area and returns within a specified time.

Additionally, the set of rules extensions is stored in the storage device 118 of the processor-based system 108. Further, a rule-template may also optionally be provided together with the system 100 to enable the supervising adult to define any rule extension when a need arises. A corresponding rules management program may also be provided with the system 100 to facilitate the management (e.g. addition or deletion) of all the rules defined therein. Whenever detection of a subject is made by the system 100, details of the detection are electronically recorded by the system 100 as an event entry into a log file stored on the processor-based system 108. The details recorded preferably include the height of the detected subject, time of the detection made, the respective rules used and the like. Further, selective recording of such event entries may also be provided as an optional feature of the system 100 wherein specific types of detection for example those related to detection of adults are not recorded for privacy preservation purposes.

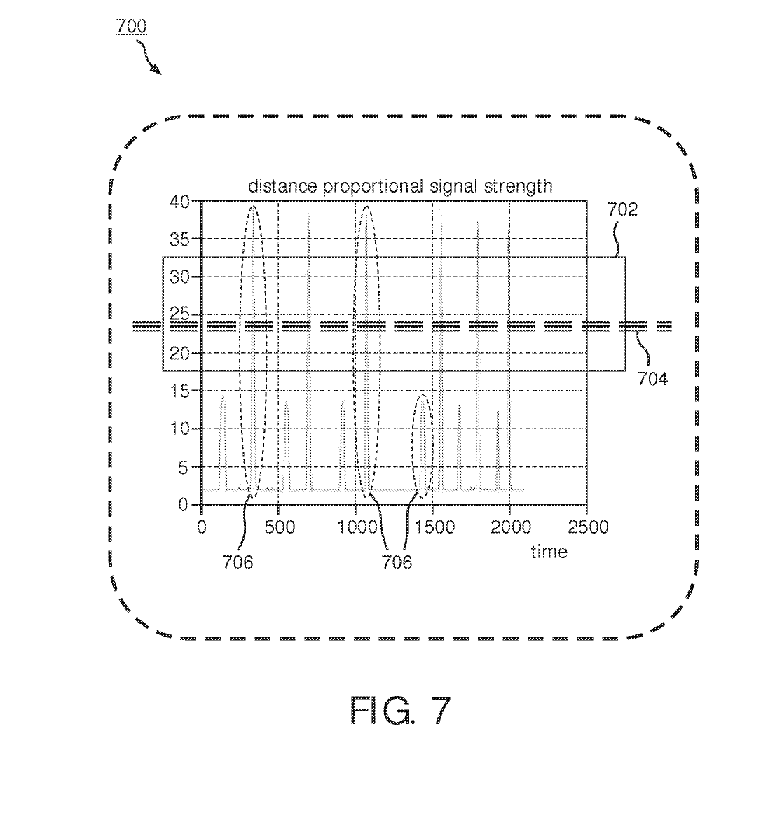

FIG. 7 shows a graph 700 of the measured heights of subjects detected by the system 100 as a function of time. The grey band 702 indicates a zone in which the threshold distance 310 may be defined and a dashed-line 704 as indicated therein is an example. Thus correspondingly, each of the spikes 706 as depicted on the graph 700 is a measured reference distance 314 of the respective subjects detected by the system 100 with the progress of time. Those spikes 706 that exceed the threshold distance 310 are each indicative of a child detection instance and signals that an alert needs to be raised by the system 100.

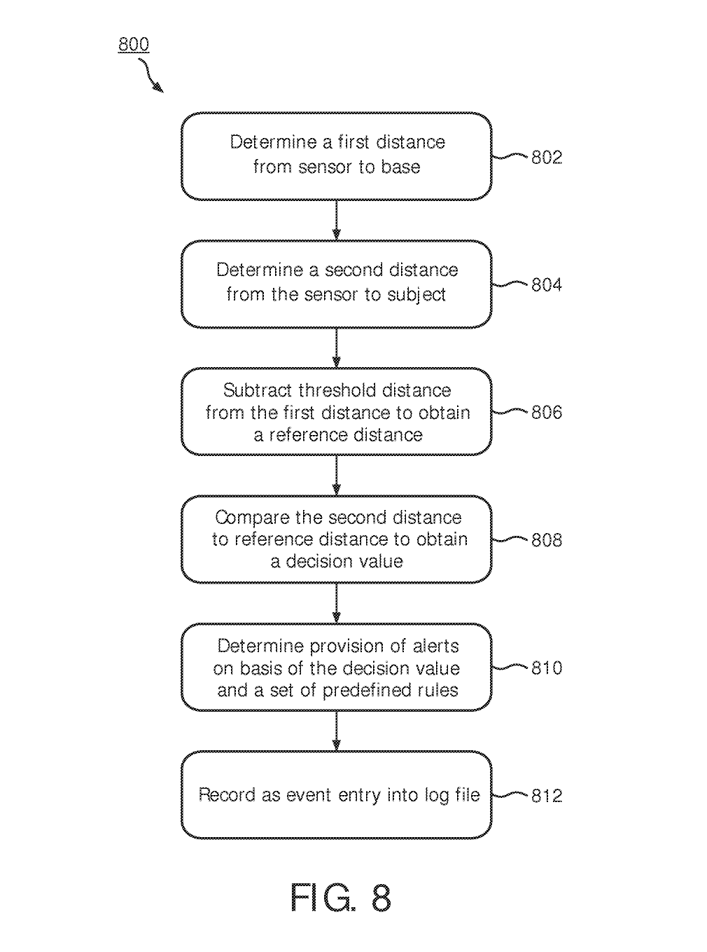

FIG. 8 is a flow diagram outlining steps of a first scheme 800 under which the system 100 is operated in accordance to the embodiment shown in FIG. 3. In a step 802, the system 100 determines the first distance 308 as measured from the sensor 102 to the base 106. The support 104, on which the sensor 102 is mounted to, is secured to the base 106. Next, the second distance 312 is then determined, as measured from the sensor 102 to a detected subject in a step 804. Thereafter, in a step 806, the threshold distance 310 is subtracted from the first distance 308 to obtain the reference distance 314.

Subsequently, the second distance 312 is compared to the reference distance 314 to obtain a decision value in a step 808. In a step 810, the decision value is used in combination with a set of predefined rules to determine the provision of alerts corresponding to a detected characteristic of the subject. In one embodiment, the determination of provision of alerts may result in one of providing no alert and at least one of providing an alert and transmitting an electronic message. The electronic message includes at least one of the following: emails, short-message-service (SMS) messages and voicemail messages. Finally, in a step 812, the system 100 records the detection of the subject as a corresponding event entry into a log file that is stored on the processor-based system 108.

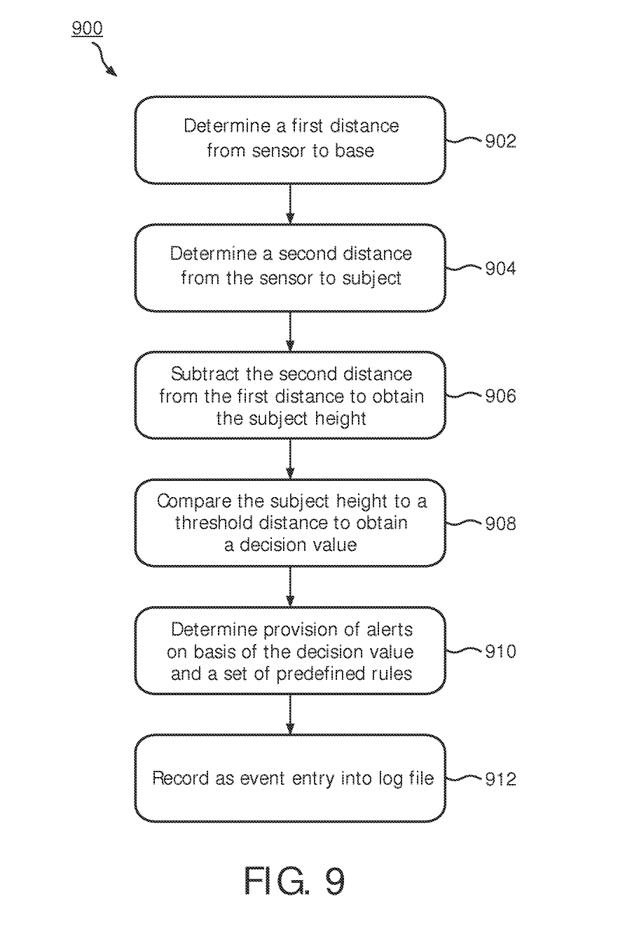

FIG. 9 is a flow diagram outlining steps of the scheme 900 under which the system 100 is operated in accordance to the embodiment shown in FIG. 4. In a step 902, the system 100 determines the first distance 308 as measured from the sensor 102 to the base 106. The support 104, on which the sensor 102 is mounted, is secured to the base 106. Next, the second distance 312 is then determined, as measured from the sensor 102 to a detected subject in a step 904. In a further step 906, the second distance 312 is subtracted from the first distance 308 to obtain the subject height 402.

Thereafter, the subject height 402 is compared to the threshold distance 310 to obtain a decision value in a step 908. In a step 910, the decision value is used in combination with a set of predefined rules to determine the provision of alerts corresponding to a detected characteristic of the subject. In one embodiment, the determination of provision of alerts may result in one of providing no alert and at least one of providing an alert and transmitting an electronic message. The electronic message includes at least one of the following: emails, short-message-service (SMS) messages and voicemail messages. Lastly, in a step 912, the system 100 records the detection of the subject as a corresponding event entry into a log file that is stored on the processor-based system 108.

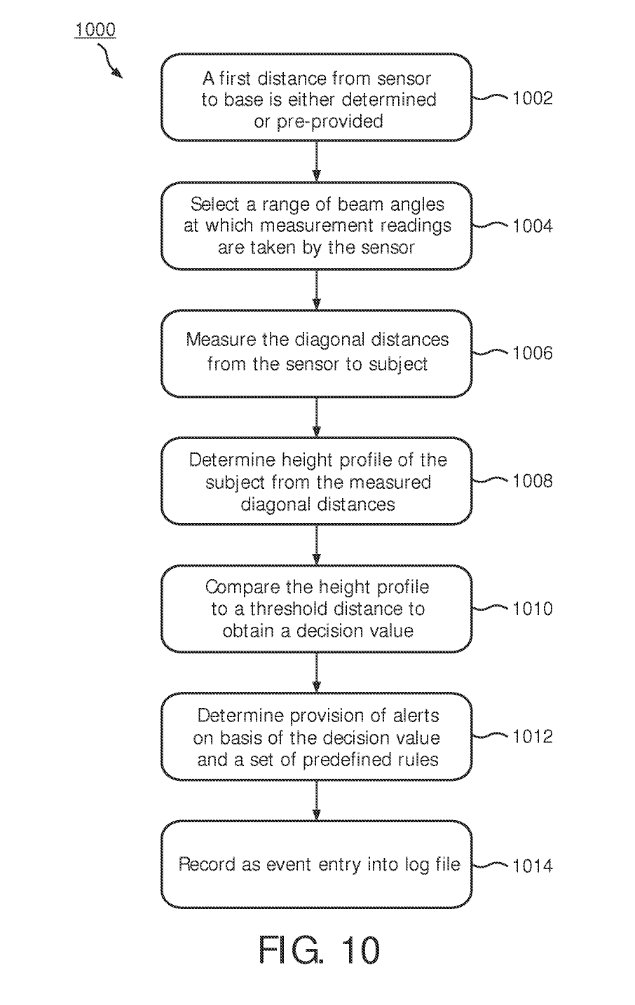

FIG. 10 is a flow diagram outlining steps of the scheme 1000 under which the system 100 is operated in accordance to the embodiment shown in FIG. 6. In a step 1002, the system 100 determines the first distance 308 as measured from the sensor 102 to the base 106. Alternatively, the first distance 308 may be pre-provided. The support 104, on which the sensor 102 is mounted to, is secured to the base 106. Next, a range of beam angles 602a, 602b at which measurement readings are to be taken by the sensor 102 with respect to, is selected and configured in the system 100 in a step 1004. In a further step 1006, the diagonal distances 606a, 606b are then measured by the sensor 102. The diagonal distance is defined to be the length spatially measured from the sensor 102 to the head of the subject 604.

Subsequently in a step 1008, all the measured diagonal distances 606a, 606b are statistically averaged to obtain a height profile (DO that is representative of the subject 604. The height profile (D_{H}′) is then compared to the threshold distance 310 to obtain a decision value in a step 1010. In a step 1012, the decision value is used in combination with a set of predefined rules to assess whether alerts are to be provided or not based on a detected characteristic of the subject 604. In one embodiment, the determination of provision of alerts may result in one of providing no alert and at least one of providing an alert and transmitting an electronic message. The electronic message includes at least one of the following: emails, short-message-service (SMS) messages and voicemail messages. Lastly, in a step 1014, the system 100 records the detection of the subject as a corresponding event entry into a log file that is stored on the processor-based system 108.

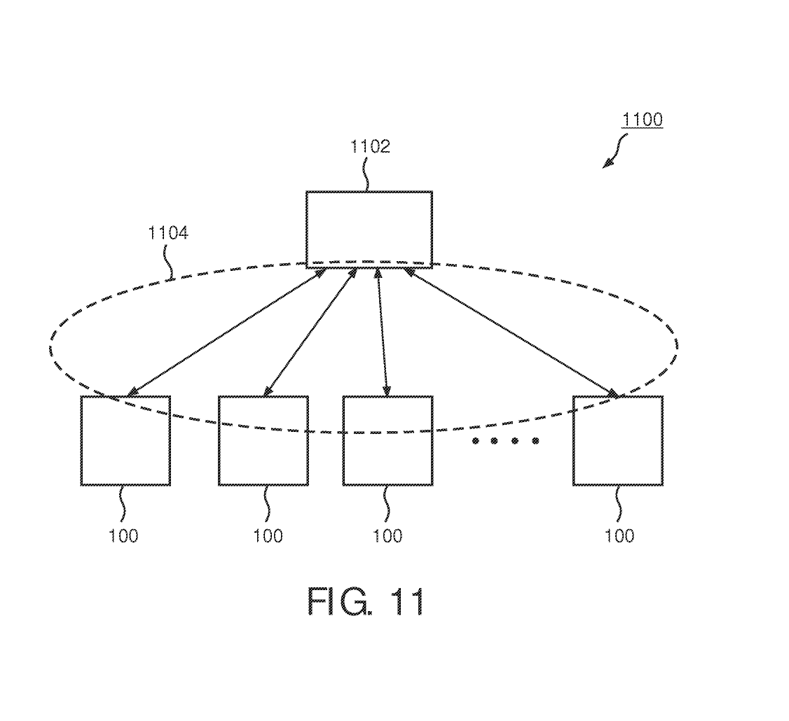

In a further embodiment, the system 100 is networkable with a plurality of other similar systems 100 as shown in FIG. 11 to support usage of advanced applications. Specifically, the plurality of systems 100 are communicatively linked to and controlled via a master control unit 1102. The communication links 1104 between the master control unit 1102 and the plurality of systems 100 are established using conventional wired or wireless means as known to persons skilled in the art. Optionally, a mixture of wired and wireless means may also be used for establishment of the communication links 1104. Alternatively, wireless communication may take place between the systems 100 without a master control unit 1102.

Yet further, in another embodiment of the invention, the respective schemes 800, 900, 1000 of FIGS. 8 to 10 may be realized as computer readable code (i.e. programming instructions) on a computer readable storage medium. The computer readable storage medium is any data storage device that can store data which can thereafter be read by a computer system, including both transfer and non-transfer devices. Examples of the computer readable storage medium include read-only memory (ROM), random-access memory (RAM), CD-ROMs, Flash memory cards, DVDs, Blu-ray Discs, magnetic tape, optical data storage devices, and carrier waves. The computer readable storage medium can also be distributed over network-coupled computer systems so that the computer readable code is stored and executed in a distributed fashion.

Examples of the invention describe a child monitoring system and method for detecting and discriminating between children and adults passing under a sensor that is independent of the position of the sensor in relation to the subject. The system determines a distance to a surface on which a person can stand, and calculates a reference distance from this distance and a desired threshold. When a person enters the sensor range, the distance to the top of the person's head is compared with the reference distance to determine whether the person is an adult or a child. An alert can be provided when a child is detected as opposed to an adult, and alerts can be suppressed if an adult is in the vicinity.

While the invention has been illustrated and described in detail in the drawings and foregoing description, such illustration and description are to be considered illustrative or exemplary, and not restrictive; the invention is not limited to the disclosed embodiments.

Other variations to the disclosed embodiments can be understood and effected by those skilled in the art in practising the claimed invention. In the claims, the term ‘comprising’ does not exclude other elements or steps and the indefinite article ‘a’ or ‘an’ does not exclude a plurality. A single processor or other unit may fulfill the functions of several items recited in the claims. The mere fact that certain measures are recited in different dependent claims does not mean that a combination of these measures cannot be used to advantage.

Any reference signs in the claims should not be construed as limiting their scope.

1. A method of detecting a subject using a sensor (102) mounted above a surface (106), the method comprising:
determining a first distance (308) from the sensor (102) to the surface (106);
determining a second distance (312) from the sensor (102) to a subject (202, 204); and
determining whether to provide an alert in dependence on the first and second distances.

2. A method according to claim 1, further comprising:
determining a reference distance (314) based on the first distance and a height threshold (310);
comparing the second distance (312) to the reference distance (314); and determining whether to provide the alert in dependence on the result of the comparison.

3. A method according to claim 2, wherein determining the reference distance (314) comprises subtracting the height threshold (310) from the first distance (308).

4. A method according to claim 2, comprising providing an alert if the second distance exceeds the reference distance.

5. A method according to claim 1, further comprising:
subtracting the second distance (312) from the first distance (308) to determine a height of the subject; and
comparing the height of the subject to a height threshold (310) to determine whether to provide the alert.

6. A method according to claim 1, comprising:
measuring the second distance based on a known angle of the sensor with respect to the subject; and
calculating the height of the subject based on the measured second distance, the first distance and the angle.

7. A method according to claim 1, comprising providing an alert by using a result of the comparison in combination with one or more rules governing the provision of alerts to a user.

8. A method according to claim 7, comprising providing an alert when a child passes under the sensor and not providing an alert when an adult passes under the sensor.

9. A method according to claim 7, comprising suppressing an alert raised as a result of a child passing under the sensor in accordance with conditions set in the one or more rules.

10. A method according to claim 7, wherein determining the first distance (308) is performed during a calibration phase (302).

11. A method according to claim 9, wherein determining the first distance (308) is performed at predetermined intervals during operation of the sensor.

12. A method according to claim 9, further comprising:
recording the detection of the subject as an event entry on a processor-based system (108) coupled to the sensor (102):

13. A computer program, which when executed on a processor, is arranged to perform a method according to claim 9.

14. A system for detecting a subject positioned on a surface, the system comprising:
a sensor (102) mountable to a support (104) for detecting the subject; means for determining a first distance (308) from the sensor (102) to the surface (106) under the sensor;
means for determining a second distance (312) from the sensor (102) to a subject; and means for determining whether to provide an alert in dependence on the first and second distances.

15. A system according to claim 14, wherein the sensor comprises a first sensor, further comprising a second sensor, wherein the first sensor is arranged with a narrow beam to detect a child under the sensor, and the second sensor is arranged with a wider beam to detect an adult further away from the sensor.
